(19) United States
(12) Patent Application Publication
(10) Pub. No.: US 2005/0275993 A1
(43) Pub. Date: Dec. 15, 2005

(54) System and method for detecting failure of a relay based circuit

(76) Inventor: Terry G. Phillips, Meridianville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/117,068

(22) Filed: Apr. 28, 2005

Related U.S. Application Data
(60) Provisional application No. 60/579,757, filed on Jun. 15, 2004.

(51) Int. Cl. H02H 5/04

(52) U.S. Cl. 361/103

(57) ABSTRACT

A system comprises a relay, a device, a temperature sensor, and a controller. The relay has a conductive component that generates heat when current flows through the conductive component, and the device is coupled to the relay such that power is provided to the device via the relay. The temperature sensor is positioned in close proximity to the relay such that temperatures sensed by the temperature sensor are affected by the heat. The controller is electrically coupled to the temperature sensor and is configured to detect failure of the relay or the device based on the sensed temperatures.

### CROSS REFERENCE TO RELATED APPLICATION

This application claims priority to U.S. Provisional Application No. 60/579,757, entitled “System and Method for Detecting Failure of Relay Based Circuit,” and filed on Jun. 15, 2004, which is incorporated herein by reference.

### TECHNICAL BACKGROUND

Devices such as hot water heaters, furnaces, and other appliances commonly include one or more heating elements that are controlled by a controller such as a thermostat. A heating element is activated (i.e., placed in an on-state) when heat is needed and deactivated (i.e., turned to an off-state) when heat is not required. Activation or deactivation of the heating element normally occurs when a control signal transitions a power relay between and open state and a closed state. Power relays have a pair of contacts capable of meeting the current requirements of the heating element. In a typical home-use hot water heater, approximately 220 volts AC from a power source is placed across the heating element and a current of about 10 to 20 amperes flows.

A heating element is typically associated with an upper temperature threshold, referred to as the “upper set point,” and a lower temperature threshold, referred to as the “lower set point,” that are used for control of the heating element. When the temperature of water in a tank exceeds the upper set point, as measured by a thermal sensor mounted on a wall of the water heater, the heating element is deactivated, and heating of the water by the heating element stops. If the water temperature drops below the lower set point, the heating element is activated and, therefore, begins to heat the water. As heated water is repeatedly withdrawn from the water tank and replenished with cold water, the heating element goes through activation/deactivation cycles.

One problem associated with water heaters is identifying the failure of power system components, such as relays and heating elements, that are used to convert the electrical energy from the power source into heat for heating water within a water heater tank. The typical hot water heater has two sets of power system components, one set in the upper section of the tank and the other set in the lower section of the tank. The two sets (an upper set and a lower set) of power system components function together in accordance with a control procedure provided by a controller. When a component of one set of power system components fails, then water is heated by the other set of power system components. However, the functioning set of power system components may be unable to sufficiently heat the water to satisfy the hot water requirements expected by a user. Hence, it is desirable to identify the failure of power system components and to notify a user of such failure so that the user can initiate repair of the failed power system components. Further, there is a need to identify component failure for both the upper and lower power system components.

### SUMMARY OF DISCLOSURE

Generally, the present disclosure pertains to systems and methods for detecting a failure of a relay based circuit.

A system in accordance with one exemplary embodiment of the present disclosure comprises a relay, a device, a temperature sensor, and a controller. The relay has a conductive component that generates heat when current flows through the conductive component, and the device is coupled to the relay such that power is provided to the device via the relay. The temperature sensor is positioned in close proximity to the relay such that temperatures sensed by the temperature sensor are affected by the heat. The controller is electrically coupled to the temperature sensor and is configured to detect failure of the relay or the device based on the sensed temperatures.

A method in accordance with one exemplary embodiment of the present disclosure comprises the steps of: causing current to flow through a relay; powering a device coupled to the relay based on the current; sensing temperatures via a temperature sensor, the temperature sensor positioned in close proximity to the relay such that the sensed temperatures are affected by heat that is generated by the current as the current is flowing through the relay; and identifying a failure of the device or the relay based on the sensed temperatures.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 illustrates an exemplary embodiment of a water heating system.

FIG. 2 illustrates a more detailed view of a relay depicted in FIG. 1.

FIG. 3 illustrates a graphic temperature profile corresponding to temperatures sensed by a temperature sensor depicted in FIG. 2.

FIG. 4 depicts a flow chart illustrating an exemplary methodology for identifying power system component failure for the system of FIG. 1

### DETAILED DESCRIPTION

Reference will now be made in detail to embodiments of the disclosure, examples of which are illustrated in the accompanying figures. Wherever possible, the same reference numerals will be used throughout the drawing figures to refer to the same or like parts.

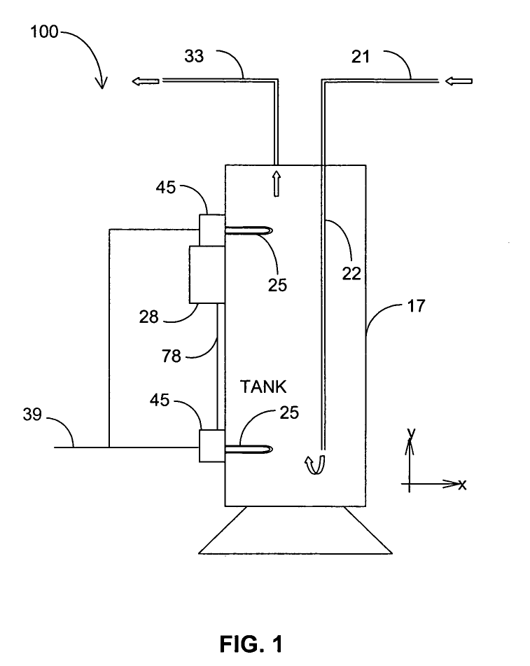

Generally, and as depicted in FIG. 1, a water heating system 100 has a controller 28 and power system components, including at least one heating element 25 located within a water tank 17 and at least one relay 45 for applying electrical power to the heating element 25. Cold water is supplied to the water tank 17 by cold water pipe 21, and the cold water flows down (in the negative y direction) a filler tube 22 into the bottom section of the tank 17. Hot water is drawn from the upper section of the tank 17 through hot water pipe 33. Note that FIG. 1 depicts two heating elements 25, an upper heating element (in the upper section or half of the tank 17) and a lower heating element (in the lower section or half of the tank 17). Other numbers and locations of heating elements may be used in other embodiments.

Activation/deactivation of each heating element 25 is controlled, in part, by a respective relay 45. FIG. 1 depicts two such relays, one for controlling the upper heating element 25 and the other for controlling the lower heating element 25. The relays 45 receive power from an alternating current (AC) power source (not shown) using power wire pair 39, where the voltage across the wire pair in one embodiment is generally around 220 Volts (V) AC.

Each respective relay 45 is controlled by a control signal, generally a low voltage, provided by the controller 28. The relay 45 has a coil (not shown), sometimes called a winding, that provides, in conjunction with magnetic material in the relay 45, an electromagnetic force for closing contacts of the relay. In this regard, when a control current from the controller 28 flows in the coil, electromagnetic force induced by the flow of current through the coil pushes the relay contacts into a closed position, and current flows to the heating element 25. When the control current is removed, the electromagnetic force no longer forces the contacts into a closed state, and a force (such as a mechanical force) pushes the contacts to an open state. Thus, current no longer flows to the heating element 25. Generally, each of the relays 45 of FIG. 1 is independently transitioned between closed and open states so as to independently provide current to each of the heating elements 25. There are numerous types of relays that can be used to implement the relays 45 depicted in FIG. 1. U.S. Pat. Nos. 3,946,347; 4,010,433; 4,616,201; 5,216,396; 5,339,059; and 5,568,349, which are each incorporated herein by reference, describe various conventional relays that may be used to implement any of the relays 45 of the present disclosure. Other known or future-developed relays are also possible.

The controller 28 can have a user interface capable of providing information about the water heating system 100 and in addition enabling a user to provide commands or information to the controller 28. An exemplary controller 28 is described in U.S. patent application Ser. No. 10/772,032, entitled “System and Method for Controlling Temperature of a Liquid Residing within a Tank,” which is incorporated herein by reference. The controller 28 can process both user and sensor input using a control strategy for generating control signals, which independently control the relays 45 and hence the activation and deactivation of the heating elements 25. The controller 28 may be implemented in hardware, software, or a combination thereof.

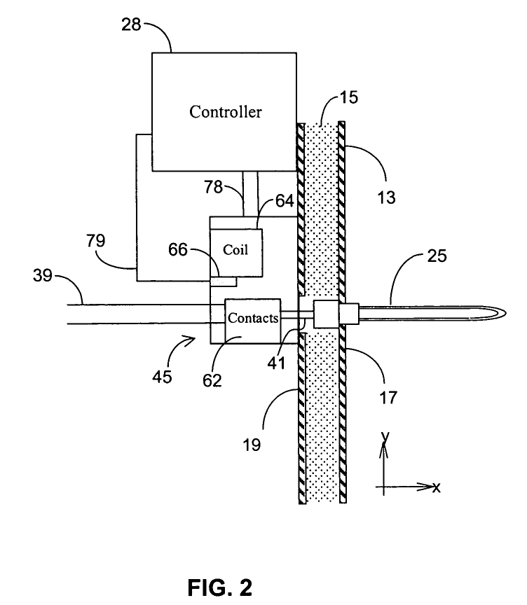

FIG. 2 illustrates a more detailed view of one of the relays 45 depicted in FIG. 1. As shown by FIG. 2, the tank 17 can be comprised of a cylindrical container having a container wall 13 for holding water, a cylindrical shell 19 that surrounds the cylindrical container and insulation 15 therebetween. The heating element 25 extends through a hole passing through the wall 13, insulation 15, and shell 19. The heating element 25 also has a connector block (not shown) for receiving power from power wire pair 39 via relay 45 and relay power wires 41. The connector block has two terminals that are connected to the power relay wires 41 so that the heating element 25 receives power when the contacts of the relay 45 are closed. The controller 28 has a control line 78 for activating relay 45. The heating element 25 and relay 45 as shown in FIG. 2 may be referred to as the “upper” power system components (when in the upper section of the tank 17) or as the “lower” power system components (when in the lower section of the tank 17).

The relay 45, as seen in FIG. 2, has a conductive coil 64 and conductive contacts 62. A sensor 66 for detecting temperatures within the relay 45 is shown positioned between the coil 64 and the contacts 62. In one embodiment of the disclosure, the sensor 66 is mounted directly to the coil 64 and is able to sense temperature changes in both the coil 64 and the contacts 62. A sensor wire 79 provides an electrical coupling for transferring temperature information from the sensor 66 to the controller 28. An increase in the temperature of the coil 64 commences when current flows in the coil 64 in response to the control signal from the controller 28 over the control line 78. Because the sensor 66 is mounted in close proximity to the coil 66, the temperature increase from coil current can be promptly observed by the controller 28 using the sensor wire 79. When the current from power wire pair 39 flows through the contacts 62 of the relay 45, heat is generated due primarily to contact resistance. However, the temperature increase due to the current flow in the contacts 62 is not immediately observed by the sensor 66 because of thermal lag. In this regard, it takes a finite amount of time, depending on the location of the sensor 66 relative to the contacts 62, for heat to propagate from the contacts 62 to the temperature sensor 66.

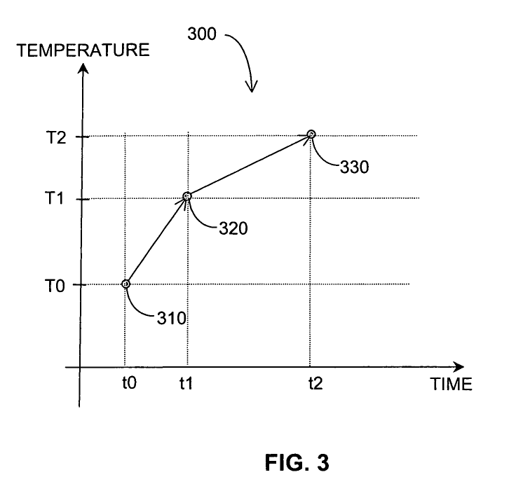

Exemplary changes in temperatures observed by the sensor 66 are graphically illustrated in FIG. 3. Assume that the heating element 25 is activated at approximately time t0 by initiating the flow of current through the coil 64 such that the contacts 64 transition to a closed state and current, therefore, flows to the heating element 25. The temperatures sensed by sensor 66 quickly go from an ambient temperature, T0 at time t0 (point 310) to a coil induced temperature T1 at time t1 (point 320). The increased temperature T1 at point 320 is primarily caused by heat generated by current flow in the coil 64. The temperature sensed by the sensor 66 at a later time t2 reaches a temperature T2 (point 330). The increased temperature T2 is primarily the result of heat generated by current flowing in the coil 64 and current flowing in the contacts 62. The ambient temperature T0 is the temperature sensed when there has been no current flow in either the coil 64 or the contacts 62 for a sufficiently long period of time such that heat previously generated by current flowing through either the coil 64 or the contacts 62 has no significant effect on the temperature sensed by the sensor 66. When the temperatures from the sensor 66 depart significantly from the illustrated profile, the controller 28 can be configured to detect a failure of either the relay 45 or the heating element 25.

A frequent source of relay failure is an open in the wire of the coil 64. When there is an open in the coil wire, current cannot flow in the coil 64 and heat is not generated by the coil 64. In addition, if no current flows in the coil 64, then the contacts 62 of relay 45 will not transition to a closed state, and no current will flow to the heating element 25 from the power wire pair 39. Hence, if a control signal is provided by the controller 28 to the relay 45 at time t0 and if, at time t1, there has been essentially no increase in temperature (i.e., the measured temperature is below T1), then the controller 28 detects a failure of the relay 45. If there is a change in temperature at time t1 to a temperature value approximately equal to T1, then the relay 45 is functioning as expected, and it is assumed that the relay 45 has not failed. If the relay 45 has not failed and there is no increase in temperature to a value approximately equal to T2 at time t2, then it is assumed that the heating element 25 has failed. Thus, the controller 28 is configured to detect a failure of the heating element 25 if the temperature sensed by the sensor 66 does not approach close to T2 at time t2 assuming that the temperature sensed by the sensor 66 at time t1 is close to T1. Hence, the failure of a power system component may be identified by the controller 28 using sensed temperatures in accordance with the above described disclosure.

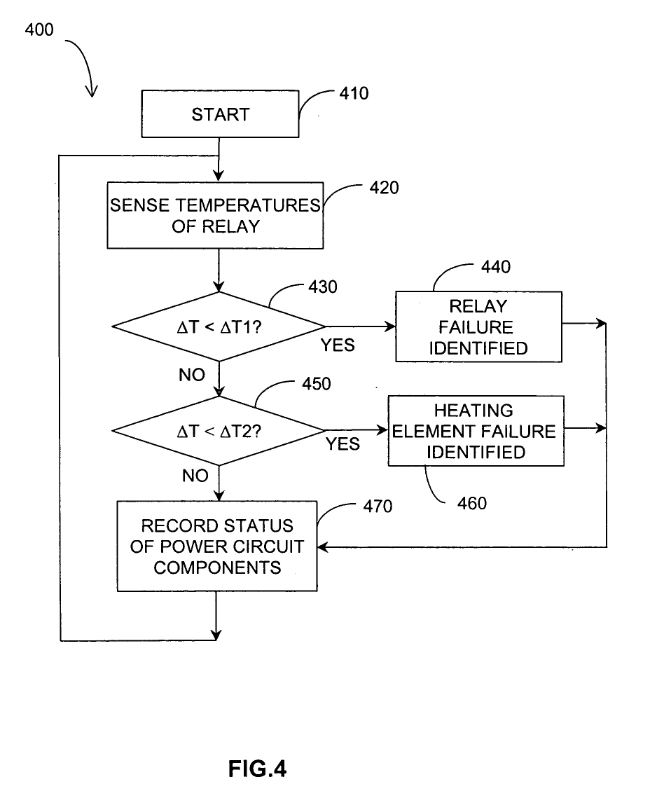

FIG. 4 is a flow chart showing an exemplary methodology 400, which may be implemented by controller 28, for identifying the failure of a power system component. The methodology 400 is initiated at the start step 410. Temperatures, T, are sensed by the sensor 66, step 420, and a temperature increment, ΔT, is calculated by subtracting the ambient temperature T0 (the temperature at t0) from the current temperature T. At time t1, the value of ΔT is compared to a first specified threshold value, ΔT1, comparison step 430. If ΔT is less than ΔT1 at time t1, then the method has identified a relay failure as shown in block 440. However, if ΔT is greater than or equal to ΔT1 at time t1, then the method continues to step 450. At time t2, the value of ΔT is then compared to a second specified threshold value, ΔT2, comparison step 440, where ΔT2 is greater than ΔT1. If ΔT is less than ΔT2 at time t2, then the method has identified a heating element failure as shown by block 460. However, if ΔT is greater than or equal to ΔT2 at time t2, then the method continues to step 470. In step 470, the status of the power system components can be recorded to indicate that such components were determined to be operating correctly between the times t0 and t2.

The temperature sensor 66 is described above as being mounted on the relay 45 of FIG. 2 and, in particular, on the coil 64 of the relay 45. However, the sensor 66 may be positioned differently in other embodiments. For example, the sensor 66 may be mounted on other portions of the relay 45. In another embodiment, the sensor 66 may be positioned within close proximity of the relay 45 but not directly to the relay 45. In such an embodiment, the relay 45 is preferably located close enough to the relay 45 such that it can detect a temperature change resulting from the heat generated by current flowing through the coil 64 and a temperature change resulting from the heat generated by current flowing through the contacts 62. As an example, the sensor 66 and the relay 45 may be mounted on a board or other base (not shown), and the sensor 66 may be able to measure the board or base temperature, which changes due to heat from current flowing through the coil 64 and heat from current flowing through the contacts 66. In addition, the sensor 66 may be close enough to the relay 45 such that it is able to detect the temperature of air affected by the heat emanating from the coil 64 and heat emanating from the contacts 62. Various other positions of the sensor 66 relative to the relay 45 are possible.

In addition, multiple temperature sensors 66 may be used, if desired. For example, one temperature sensor 66 can be used to detect temperature changes resulting from heat generated by current flowing through the coil 64, and another sensor 66 can be used to detect temperature changes resulting from heat generated by current flowing through the contacts 62.

Further, comparing the data from the sensor 66 to multiple thresholds is unnecessary. For example, the data from the sensor 66 can be analyzed to determine whether the measured temperatures exceed a single threshold for detecting a failure of the relay 45 or heating element 25. In this regard, if the sensed temperatures do not reach a specified threshold shortly after activation of the relay 45, then the controller 28 can detect failure of the relay 45 or the heating element 25. Thus, in various embodiments, such as when multiple temperature sensors or a single threshold are used, it is possible for a sensor 66 to be positioned such that it is able to detect temperature changes due to heat from the coil 64 and not from the contacts 62, and it is possible for the sensor 66 to be positioned such that it is able to detect temperature changes due to heat from the contacts 62 and not from the coil 64.

It should be emphasized that the above-described embodiments of the present invention are merely possible examples of implementations and set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A system, comprising:
a relay having a conductive component that generates heat when current flows through the conductive component;
a device coupled to the relay such that power is provided to the device via the relay;
a temperature sensor positioned in close proximity to the relay such that temperatures sensed by the temperature sensor are affected by the heat; and
a controller electrically coupled to the temperature sensor, the controller configured to detect failure of the relay or the device based on the sensed temperatures.

2. The system of claim 1, wherein the temperature sensor is mounted on the relay.

3. The system of claim 1, wherein the temperature sensor is mounted on a coil of the relay.

4. The system of claim 1, wherein the controller is configured to perform a comparison between a threshold value and a value indicative of a temperature change sensed by the temperature sensor, the controller further configured to detect a failure of the relay based on the comparison.

5. The system of claim 4, wherein the controller is configured to perform a second comparison between a second threshold value and a value indicative of a second temperature change sensed by the temperature sensor in order to detect a failure of the device.

6. The system of claim 1, wherein the controller is configured to perform a comparison between a threshold value and a value indicative of a temperature change sensed by the temperature sensor, the controller further configured to detect a failure of the device based on the comparison.

7. The system of claim 1, wherein the device is a heating element of a water heater.

8. A method, comprising the steps of:
causing current to flow through a relay;
powering a device coupled to the relay based on the current;
sensing temperatures via a temperature sensor, the temperature sensor positioned in close proximity to the relay such that the sensed temperatures are affected by heat that is generated by the current as the current is flowing through the relay; and
detecting a failure of the device or the relay based on the sensed temperatures.

9. The method of claim 8, wherein the temperature sensor is mounted on the relay.

10. The method of claim 8, wherein the temperature sensor is mounted on a coil of the relay.

11. The method of claim 8, wherein the device is a heating element of a water heater.

12. The method of claim 8, further comprising the steps of:
determining a first value indicative of a first change in the sensed temperatures;
comparing the first value to a first threshold,
wherein the detecting step is based on the comparing step.

13. The method of claim 12, further comprising the steps of:
determining a second value indicative of a second change in the sensed temperatures;
comparing the second value to a second threshold,
wherein the second threshold is different than the first threshold.

14. A method, comprising the steps of:
providing power to device via a relay;
sensing temperatures via a temperature sensor, the temperature sensor positioned in close proximity to the relay such that the sensed temperatures are affected by heat that is generated by current as the current is flowing through the relay;
determining a first value indicative of a first change in the sensed temperatures;
determining a second value indicative of a second change in the sensed temperatures;
comparing the first value to a first threshold;
comparing the second value to a second threshold, wherein the first and second thresholds are different; and
detecting a failure of the electrical component or the relay based on each of the comparing steps.

15. The method of claim 14, wherein the device is a heating element of a water heater.

16. The method of claim 14, wherein the temperature sensor is mounted on the relay.

17. The method of claim 14, wherein the temperature sensor is mounted on a coil of the relay.

18. The method of claim 14, wherein the first temperature change is indicative of whether current is flowing through a coil of the relay, and wherein the second temperature change is indicative of whether current is flowing through contacts of the relay.
